(19) United States
(12) Patent Application Publication
(10) Pub. No.: US 2010/0326039 A1
(43) Pub. Date: Dec. 30, 2010

(54) GAS TURBINE, DISK, AND METHOD FOR FORMING RADIAL PASSAGE OF DISK

(75) Inventors: Kenichi Arase, Hyogo-ken (JP); Shinya Hashimoto, Hyogo-ken (JP)

Correspondence Address: LOWE HAUPTMAN HAM & BERNER, LLP, 1700 DIAGONAL ROAD, SUITE 300, ALEXANDRIA, VA, 22314, US

(73) Assignee: MITSUBISHI HEAVY INDUSTRIES, LTD., Tokyo (JP)

(21) Appl. No.: 12/865,641

(22) PCT Filed: Dec. 24, 2008
(86) PCT No.: PCT/JP2008/073483

§ 371 Date: Jul. 30, 2010

(30) Foreign Application Priority Data
Feb. 28, 2008 (JP) 2008-048249

(51) Int. Cl. F02C 3/00; B23P 17/00

(52) U.S. Cl. 60/39.01; 29/888

(57) ABSTRACT

A gas turbine includes a disk rotatable about a rotational axis, when turbine rotor blades for receiving combustion gas obtained by burning fuel are connected to the side periphery, and energy of the combustion gas received by the turbine rotor blades is transmitted, and a radial passage that, in a cross-section at a virtual curved plane that is a curved plane about the rotational axis and in which distances from all points on the curved plane to the rotational axis are all equal, is a hole formed to include a portion having a shape in which the length in the circumferential direction of the disk is longer than the length in the direction parallel to the rotational axis, and is formed in the disk from the side of the rotational axis toward the outside of the disk.

### TECHNICAL FIELD

The present invention relates to a gas turbine, a disk, and a method for forming a radial passage of a disk. More specifically, the present invention relates to a gas turbine, a disk, and a method for forming a radial passage of a disk capable of cooling rotor blades by air.

### BACKGROUND ART

Conventionally, a gas turbine is an apparatus that extracts energy from combustion gas obtained by burning fuel. The gas turbine, for example, ejects fuel to compressed air, rotates a turbine by using energy of combustion gas produced by burning the fuel, and outputs rotation energy from a rotor.

For example, Patent Document 1 discloses a gas turbine that includes a turbine cooling system capable of cooling rotor blades, when a rotor blade cooling medium supplied from outside the turbine structure flows through a hollow shaft disposed in the center hole of a disk before being cooled, and guided to the outer periphery of the disk through a radial hole provided in a spacer.

[Patent Document 1] Japanese Patent Application Laid-open No. H9-242563 (paragraph number 0012)

### DISCLOSURE OF INVENTION

### Problem to be Solved by the Invention

In the gas turbine disclosed in Patent Document 1, the force is applied to the radial hole formed in the radial direction of the disk that is a rotator, in the circumferential direction by the inertial force, when the disk is rotated. At this time, depending on the shape of the radial hole, the stress may be concentrated on a particular portion.

The present invention has been made in view of the circumstances described above, and an object of the present invention is to reduce the uneven stress distribution generated in a radial passage formed in the radial direction of the disk.

### Means for Solving Problem

According to an aspect of the present invention, a gas turbine includes: a disk rotatable about a rotational axis, when a rotor blade for receiving combustion gas obtained by burning fuel is connected to a side periphery and energy of the combustion gas received by the rotor blade is transmitted; and a radial passage that, in a cross-section at a virtual curved plane that is a curved plane about the rotational axis and in which distances from all points on the curved plane to the rotational axis are all equal, is a hole formed to include a portion having a shape in which a length in a circumferential direction of the disk is longer than a length in a direction parallel to the rotational axis, and is formed in the disk from a side of the rotational axis toward an outside of the disk.

When the disk is rotated about the rotational axis, the force is applied to the radial passage in the circumferential direction of the disk. In the gas turbine according to the present embodiment, with the structure described above, the cross-section of the radial passage at the virtual curved plane is formed in an oval shape in which the length in the circumferential direction of the disk is longer than the length in the direction parallel to the rotational axis. Accordingly, in the gas turbine, the stress generated in a region that passes through the centroid of the cross-section and that is perpendicular to the force is reduced. In this manner, in the gas turbine, the uneven stress distribution generated in the radial passage is reduced.

Advantageously, in the gas turbine, the radial passage includes a portion other than that included in a virtual plane having the rotational axis.

With the structure described above, the gas turbine according to the present invention includes a portion whose cross-section of the radial passage at the virtual curved plane is naturally formed in an oval shape in which the length in the circumferential direction of the disk is longer than the length in the direction parallel to the rotational axis. Accordingly, in the gas turbine, the stress generated in the region that passes through the centroid of the cross-section and that is perpendicular to the force is reduced. In this manner, in the gas turbine, the uneven stress distribution generated in the radial passage is reduced.

In the gas turbine, the length of the passage through which cooling air flows is longer, because the radial passage is tilted relative to a virtual reference plane. Accordingly, in the gas turbine, the heat exchange between the cooling air and an object to be cooled is enhanced. In this manner, the cooling performance of the gas turbine is enhanced.

Advantageously, in the gas turbine, a first open end of the radial passage is opened to a space formed at an inner side of the side periphery of the disk, and a second open end is opened to the side periphery of the disk, and when the radial passage is projected on a plane perpendicular to the rotational axis from a direction of the rotational axis, the radial passage has an angle equal to or more than 10 degrees and equal to or less than 45 degrees relative to a virtual reference plane including the first open end and the rotational axis.

With the structure described above, in the gas turbine according to the present invention, the stress generated in the region that passes through the centroid of the cross-section and that is perpendicular to the force is more effectively reduced. In this manner, in the gas turbine, the uneven stress distribution generated in the radial passage is more effectively reduced.

Advantageously, in the gas turbine, the disk is rotatable toward a predetermined rotational direction, and the radial passage is tilted to a region opposite from the rotational direction, relative to the virtual reference plane at a portion of the first open end.

With the structure described above, in the gas turbine according to the present invention, the cooling air flows into the radial passage, because the collision of the cooling air guided to the radial passage with the wall surface of one of the open ends is eased. In other words, in the gas turbine, the cooling air flows into the radial passage easily. Accordingly, in the gas turbine, the flow velocity of the cooling air supplied to the radial passage is increased. In this manner, in the gas turbine, the heat exchange between the cooling air and an object to be cooled is enhanced. Consequently, the cooling performance of the gas turbine by the cooling air is enhanced.

According to another aspect of the present invention, a disk, in a cross-section at a virtual curved plane that is a curved plane about a rotational axis and in which distances from all points on the curved plane to the rotational axis are all equal, includes a radial passage that is a hole formed to include a portion having a shape in which a length in a circumferential direction of the disk is longer than a length in a direction parallel to the rotational axis, and that is formed in the disk from a side of the rotational axis toward an outside of the disk.

When the disk according to the present invention is rotated about the rotational axis, the force is applied to the radial passage in the circumference direction of the disk. In the disk, with the structure described above, the cross-section of the radial passage at the virtual curved plane is formed in an oval shape in which the length in the circumferential direction of the disk is longer than the length in the direction parallel to the rotational axis. Accordingly, in the disk, the stress generated in the region that passes through the centroid of the cross-section and that is perpendicular to the force is reduced. In this manner, in the disk, the uneven stress distribution generated in the radial passage is reduced.

According to still another aspect of the present invention, a method for forming a radial passage of a disk includes: a first step of attaching a disk formed in a disk shape on a drilling machine in which a drill blade is arranged in parallel with a virtual plane including a rotational axis of the disk, and being shifted from the virtual plane by a predetermined distance; a second step of forming a first radial passage that is a hole in the disk, by moving the drill blade in parallel with the virtual plane; a third step of rotating the disk about the rotational axis by a predetermined angle; a fourth step of forming a second radial passage that is a hole in the disk, by moving the drill blade in parallel with the virtual plane; and a fifth step of repeating the third step and the fourth step until a desired number of radial passages are formed in the disk.

With the structure described above, in the method for forming the radial passage of the disk according to the present invention, the radial passage can be easily formed by using a conventional machine tool. At this time, in the gas turbine including the radial passage, the cross-section of the radial passage at the virtual curved plane is formed in an oval shape in which the length in the circumferential direction of the disk is longer than the length in the direction parallel to the rotational axis. Accordingly, in the gas turbine, the stress generated in the region that passes through the centroid of the cross-section and that is perpendicular to the force is reduced. In this manner, in the gas turbine, the uneven stress distribution generated in the radial passage is reduced.

In the gas turbine, the cooling air flows into the radial passage, because the collision of the cooling air guided to the radial passage with the wall surface of one of the open ends is eased. In other words, in the gas turbine, the cooling air flows into the radial passage easily. Accordingly, in the gas turbine, the flow velocity of the cooling air supplied to the radial passage is increased. In this manner, the cooling performance of the gas turbine by the cooling air is enhanced.

In the gas turbine, the passage through which the cooling air flows is longer, because the radial passage is tilted relative to the virtual reference plane. Accordingly, in the gas turbine, the heat exchange between the cooling air and an object to be cooled is enhanced. In this manner, the cooling performance of the gas turbine is enhanced.

### EFFECT OF THE INVENTION

The present invention can reduce the uneven stress distribution generated in the radial passage formed in the radial direction of the disk.

### BRIEF DESCRIPTION OF DRAWINGS

FIG. 1 is a schematic of a gas turbine according to the present embodiment.

FIG. 2 is an enlarged schematic sectional view of a turbine of the gas turbine according to the present embodiment.

FIG. 3 is a projection view of radial passages formed in a disk according to the present embodiment, projected on a plane perpendicular to the rotational axis from the rotational axis direction.

FIG. 4 is a projection view of radial passages formed in a conventional disk, projected on a plane perpendicular to the rotational axis from the rotational axis direction.

FIG. 5 is a schematic of a side periphery of the conventional disk spread into a plane.

FIG. 6 is a schematic of a side periphery of the disk according to the present embodiment spread into a plane.

FIG. 7 is a projection view of the radial passages formed in the conventional disk near inner open ends, projected on a plane perpendicular to the rotational axis from the rotational axis direction.

FIG. 8 is a projection view of the radial passages formed in the disk according to the present embodiment near inner open ends, projected on a plane perpendicular to the rotational axis from the rotational axis direction.

FIG. 9 is a schematic for explaining a shifting amount of a drill blade from a virtual plane, while forming the radial passage according to the present embodiment.

### EXPLANATIONS OF LETTERS OR NUMERALS

1, 2 gas turbine
11 first supply passage
12 first space
13, 23 radial passage
13a, 23a open end
13b, 23b open end
14 second space
15 cooling passage
16 second supply passage
17 third space
18 fitting unit
110 turbine
111 turbine casing
112 turbine nozzle
113 turbine rotor blade
114, 214 disk
120 compressor
121 air inlet port
122 compressor housing
123 compressor vane
124 compressor rotor blade
130 combustor
140 exhaust unit
141 exhaust diffuser
150 rotor
151, 152 bearing
D drill blade
GND ground
RL rotational axis
V01 virtual plane
V02 virtual reference plane
V03 virtual curved plane

### BEST MODE(S) FOR CARRYING OUT THE INVENTION

The present invention will now be described in detail with reference to the drawings. However, the present invention is not limited to the best modes (hereinafter, embodiments) for carrying out the invention. Constituent elements according to the embodiments below include elements that can be easily assumed by a person skilled in the art, elements being substantially the same as those elements, and elements that fall within a range of so-called equivalents.

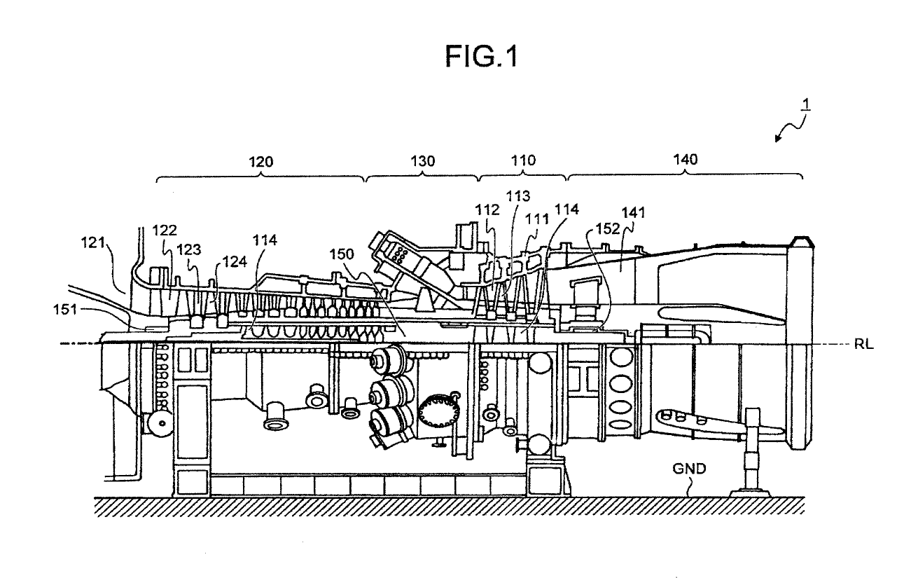

FIG. 1 is a schematic of a gas turbine according to the present embodiment. A gas turbine 1 according to the present embodiment is placed on a ground GND. The gas turbine 1 includes a compressor 120, a combustor 130, a turbine 110, and an exhaust unit 140, arranged in this order from the upstream side to the downstream side of the flow of fluid.

The compressor 120 compresses air, and delivers compressed air to the combustor 130. The combustor 130 supplies fuel to the compressed air. The combustor 130 ejects fuel to the compressed air, and burns the fuel. The turbine 110 converts energy of combustion gas delivered from the combustor 130 to rotation energy. The exhaust unit 140 exhausts the combustion gas to the atmosphere.

The compressor 120 includes an air inlet port 121, a compressor housing 122, a compressor vane 123, and a compressor rotor blade 124. Air is drawn into the compressor housing 122 from the atmosphere through the air inlet port 121. A plurality of compressor vanes 123 and a plurality of compressor rotor blades 124 are alternately arranged in the compressor housing 122.

The turbine 110, as illustrated in FIG. 1, includes a turbine casing 111, a turbine nozzle 112, and a turbine rotor blade 113. A plurality of turbine nozzles 112 and a plurality of turbine rotor blades 113 are alternately arranged in the turbine casing 111, along the direction of the flow of combustion gas. The exhaust unit 140 includes an exhaust diffuser 141 continued to the turbine 110. The exhaust diffuser 141 converts dynamic pressure of exhaust gas that has passed through the turbine 110 into static pressure.

The gas turbine 1 includes a rotor 150 as a rotator. The rotor 150 is provided so as to penetrate through the center portions of the compressor 120, the combustor 130, the turbine 110, and the exhaust unit 140.

An end of the rotor 150 at the side of the compressor 120 is rotatably supported by a bearing 151, and an end of the rotor 150 at the side of the exhaust unit 140 is rotatably supported by a bearing 152.

A plurality of disks 114 is fixed to the rotor 150. The compressor rotor blades 124 and the turbine rotor blades 113 are connected to the disks 114. A generator input shaft of a generator is connected to the end of the rotor 150 at the side of the compressor 120.

The gas turbine 1 draws in air from the air inlet port 121 of the compressor 120. The air drawn in is compressed by the compressor vanes 123 and the compressor rotor blades 124. Accordingly, the air is turned into compressed air at a temperature and a pressure higher than those of the atmosphere. The combustor 130 then supplies a predetermined amount of fuel to the compressed air, thereby burning the fuel.

The turbine nozzles 112 and the turbine rotor blades 113 of the turbine 110 convert energy of the combustion gas produced in the combustor 130 into rotation energy. The turbine rotor blades 113 transmit the rotation energy to the rotor 150. Accordingly, the rotor 150 is rotated.

With the structure described above, the gas turbine 1 drives the generator, which is not illustrated, connected to the rotor 150. The dynamic pressure of the exhaust gas that has passed through the turbine 110 is converted into static pressure by the exhaust diffuser 141, and then released to the atmosphere.

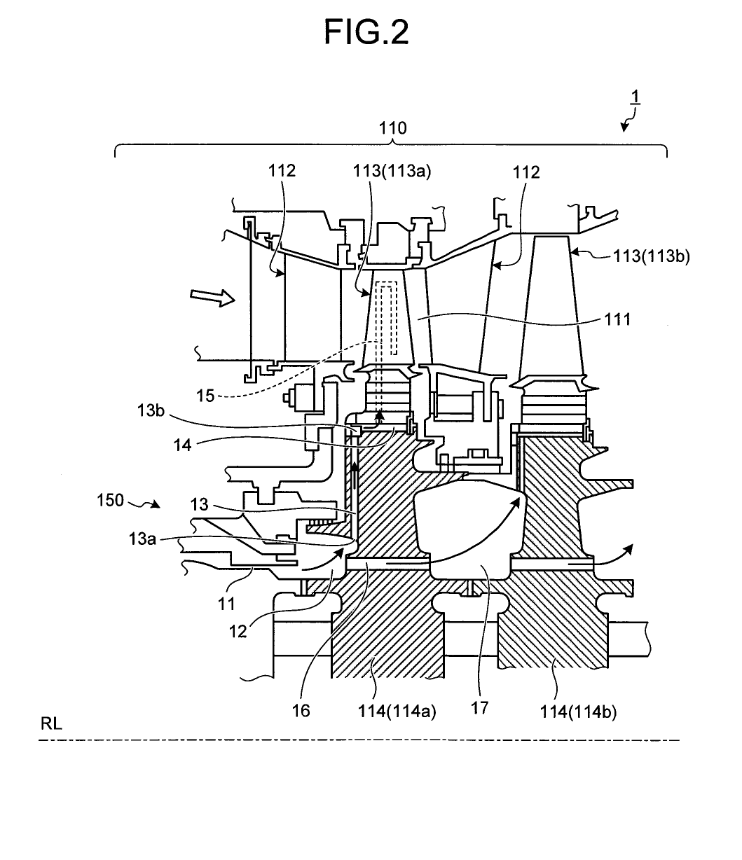

FIG. 2 is an enlarged schematic sectional view of a turbine of the gas turbine according to the present embodiment. As illustrated in FIG. 2, the rotor 150 includes the disks 114 and the turbine rotor blades 113. Each of the disks 114 rotates about a rotational axis RL illustrated in FIGS. 1 and 2. The turbine rotor blades 113 are connected to the radially outer periphery of the disk 114 formed in a disk shape, along the circumferential direction. In this manner, the turbine rotor blades 113 also rotate about the rotational axis RL with the disk 114.

The combustion gas at a temperature and a pressure higher than those of the atmosphere produced in the combustor 130 is supplied to the turbine 110. In this manner, the temperatures of the turbine rotor blades 113 and the disks 114 are increased, by receiving heat from the combustion gas. Accordingly, the gas turbine 1 supplies cooling air at a temperature lower than that of the turbine rotor blades 113 and the disks 114, to the turbine rotor blades 113 and the disks 114, thereby cooling the turbine rotor blades 113 and the disks 114.

The disks 114 and the turbine rotor blades 113 are arranged in a plurality of stages, along the flow of combustion gas. Among the disks 114, a first disk 114a and a second disk 114b are the disks 114 arranged in this order from the upstream side of the flow of combustion gas. Among the turbine rotor blades 113, a first turbine rotor blade 113a and a second turbine rotor blade 113b are the turbine rotor blades 113 arranged in this order from the upstream side of the flow of combustion gas. The first turbine rotor blade 113a is connected to the first disk 114a, and the second turbine rotor blade 113b is connected to the second disk 114b.

The turbine 110 includes a first supply passage 11, a first space 12, a radial passage 13, a second space 14, a cooling passage 15, a second supply passage 16, and a third space 17. The first supply passage 11 is a passage through which cooling air flows. The cooling air is supplied to the first supply passage 11 illustrated in FIG. 2 from the compressor 120 illustrated in FIG. 1, through a passage, which is not illustrated, and a cooler that cools the air guided from the compressor 120.

The first space 12 is formed in the rotor 150. A plurality of radial passages 13 is formed in the first disk 114a, from the inside of the first disk 114a formed in a disk shape, towards the radially outside of the first disk 114a. The second space 14 is formed between the first disk 114a and the first turbine rotor blade 113a. A plurality of cooling passages 15 is formed in the first turbine rotor blade 113a.

The cooling air is supplied from one of the open ends of the first supply passage 11, and the other end is opened to the first space 12. In this manner, the cooling air is supplied to the first space 12 through the first supply passage 11. An open end 13a of the radial passage 13 is opened to the first space 12, and the other open end 13b is opened to the second space 14. Accordingly, the cooling air in the first space 12 is supplied to the second space 14 through the radial passage 13. At this time, while passing through the inside of the radial passage 13, the cooling air exchanges heat with the first disk 114a at a temperature higher than that of the cooling air. In this manner, the cooling air cools the first disk 114a, while passing through the radial passage 13.

One of the ends of each of the cooling passages 15 is opened to the second space 14, and the other end is opened to the turbine casing 111. In this manner, the cooling air in the second space 14 is discharged to the turbine casing 111 through the cooling passage 15. At this time, while passing through the inside of the cooling passage 15, the cooling air exchanges heat with the first turbine rotor blade 113a at a temperature higher than that of the cooling air. In this manner, the cooling air cools the first turbine rotor blade 113a, while passing through the cooling passage 15.

The second supply passage 16 is formed in the first disk 114a in the direction of the rotational axis RL. The third space 17 is formed between the first disk 114a and the second disk 114b. One of the ends of the second supply passage 16 is opened to the first space 12, and the other end is opened to the third space 17. In this manner, in the cooling air in the first space 12, the cooling air that is not supplied to the radial passage 13 is guided to the third space 17, through the second supply passage 16.

The cooling air in the third space 17 cools the second disk 114b and the second turbine rotor blade 113b, by flowing through the passages, the spaces, and the cooling passages formed in the second disk 114b and the second turbine rotor blade 113b, as in the first disk 114a and the first turbine rotor blade 113a. As illustrated in FIG. 2, the radial passage 13 is formed in parallel with a plane perpendicular to the rotational axis RL. However, the radial passage 13 may be tilted relative to the plane perpendicular to the rotational axis RL.

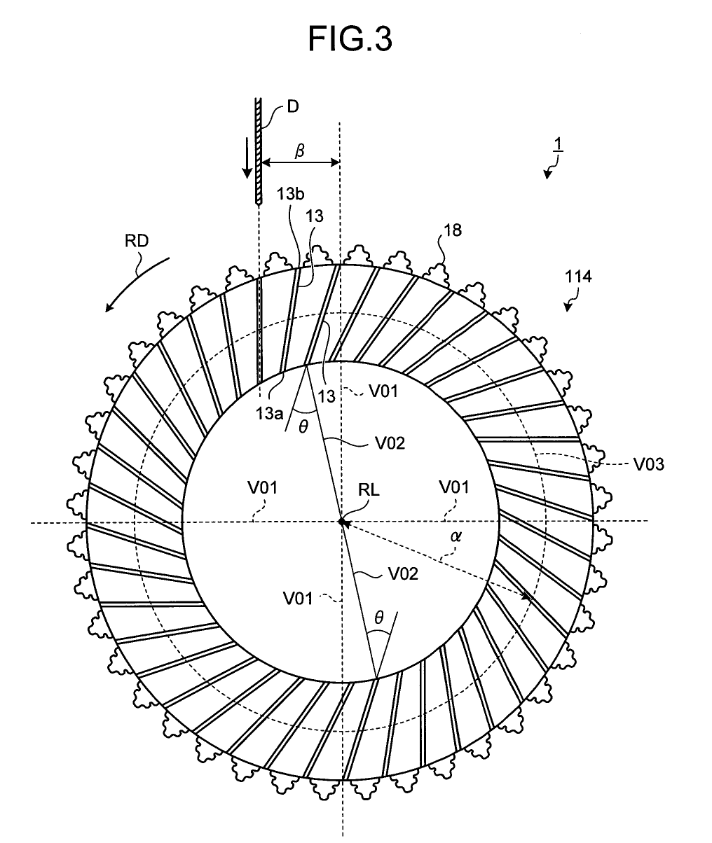

FIG. 3 is a projection view of radial passages formed in a disk according to the present embodiment, projected on a plane perpendicular to the rotational axis from the rotational axis direction. One of the features of the gas turbine 1 is the radial passages 13 formed in the disk 114.

As illustrated in FIG. 3, a virtual plane V01 is any plane that includes the rotational axis RL. The radial passages 13 are provided from the radially inside toward the radially outside of the disk 114. Each of the radial passages 13 intersects with the virtual plane V01 that passes through the rotational axis RL, or is in parallel with the virtual plane V01. However, the radial passage 13 is not completely included in the virtual plane V01. In other words, the virtual line of the radial passage 13 obtained by extending the radial passage 13 toward the radially inside of the disk 114, does not intersect with the rotational axis RL.

A virtual reference plane V02 is a virtual plane including the open end 13a of the radial passage 13, and the rotational axis RL. In the gas turbine 1, an angle θ between the virtual reference plane V02 and the radial passage 13, for example, is set to 30 degrees.

In all the radial passages 13 provided in the disk 114, the angles θ between the virtual reference planes V02 and the radial passages 13 are equally set to 30 degrees. However, the present invention is not limited thereto. In all the radial passages 13 provided in the disk 114, the angles θ between the virtual reference planes V02 and the radial passages 13 may be set differently.

Fitting units 18 illustrated in FIG. 3 are portions into which the ends of the turbine rotor blades 113 are fitted. By being fitted into a fitting unit formed at the end of the turbine rotor blade 113, the fitting unit 18 supports the turbine rotor blade 113 at the side periphery of the disk 114.

While avoiding a plurality of fitting units 18 formed at the side periphery of the disk 114, the radial passages 13 are formed from the radially outside of the disk 114 toward the radially inside of the disk 114, for example, by a drill. In this manner, the open ends 13b are opened between the fitting units 18.

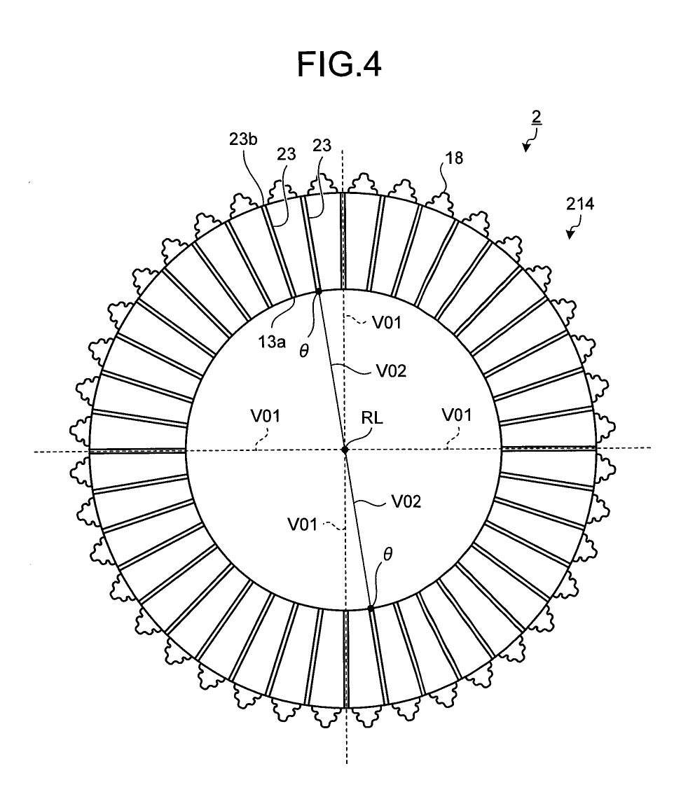

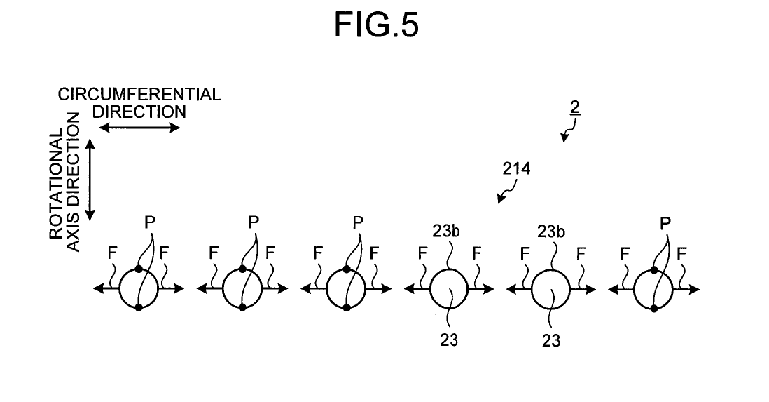

FIG. 4 is a projection view of radial passages formed in a conventional disk, projected on a plane perpendicular to the rotational axis from the rotational axis direction. FIG. 5 is a schematic of a side periphery of the conventional disk spread into a plane. A conventional gas turbine 2, as illustrated in FIG. 4, includes a disk 214 and radial passages 23 formed in the disk 214. Open ends 23b of the radial passages 23 are opened at the side periphery of the disk 214.

As illustrated in FIG. 4, if the angle θ of each of the radial passages 23 is 0 degree, each of the open ends 23b of the radial passage 23, as illustrated in FIG. 5, is almost a true circle. If the disk 214 rotates about the rotational axis RL illustrated in FIG. 4, force F is applied to the open ends 23b in the circumferential direction of the disk 214 by the inertial force. In this manner, the stress is generated at the open ends 23b. At this time, in the edge of the open end 23b that is an almost true circle, the stresses at regions P that pass though the centroid of the open end 23b and that are perpendicular to the force F become maximum. In other words, in the gas turbine 2, the stresses are concentrated on the regions P.

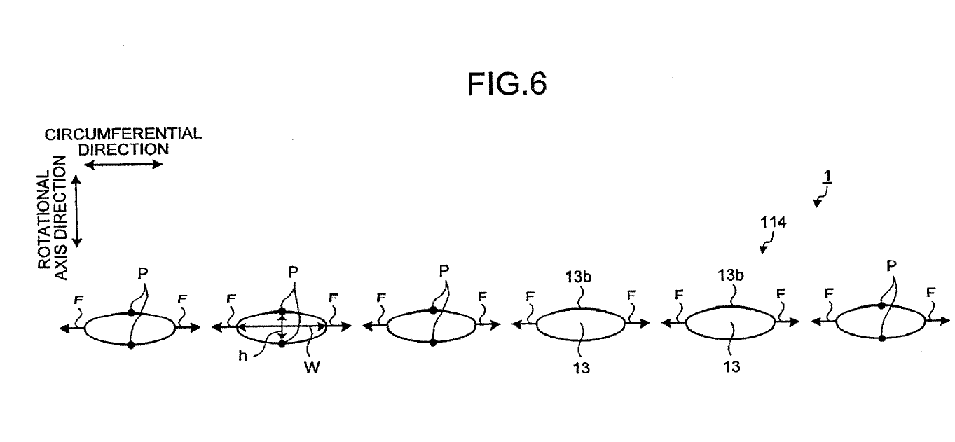

FIG. 6 is a schematic of a side periphery of the disk according to the present embodiment spread into a plane. However, as illustrated in FIG. 3, if the angle θ is set other than 0 degree, even if the radial passages 13 are formed by the drill, the open ends 13b of the radial passages 13 are formed into oval shapes longer in the circumferential direction of the disk 114, as illustrated in FIG. 6. In other words, in the open ends 13b, the length w in the circumferential direction of the disk 114 is longer than the length h in the direction parallel to the rotational axis RL.

If the disk 114 is rotated about the rotational axis RL illustrated in FIG. 3, the force F is applied to the radial passages 13 in the circumferential direction of the disk 114. At this time, if the disk 114 illustrated in FIG. 3 and the disk 214 illustrated in FIG. 4 are rotated under the same conditions, the force F applied to the open ends 13b and the force F applied to the open ends 23b are equal. However, if the shapes of the openings are different, even if the same force F is applied to the openings, the amount of stress generated in the specific region P is different.

More specifically, the stresses generated in the regions P that pass through the centroid of the open end 13b formed in an oval shape, and that is perpendicular to the force F, are smaller than the stresses generated in the regions P of the open end 23b formed in a true circle. In other words, in the gas turbine 1, the stresses generated in the regions P of the open end 13b are reduced, thereby reducing the uneven stress distribution generated in the open end 13b.

For example, if the length w in the circumferential direction of the shape of the open end 13b is smaller than the length h in the direction parallel to the rotation axis RL, the stresses generated in the regions P are increased, unlike when the length w in the circumferential direction of the disk 114 is longer than the length h in the direction parallel to the rotational axis RL.

In the gas turbine 1, if the radial passages 13 illustrated in FIG. 3 are tilted relative to the plane perpendicular to the rotational axis RL, the length h in the direction parallel to the rotational axis RL is increased in the shape of the open end 13b. In other words, if the radial passages 13 are tilted relative to the plane perpendicular to the rotational axis RL, the stresses generated in the regions P are increased.

In the gas turbine 1, the shape at each of the open ends 13a of the radial passages 13 illustrated in FIG. 3, is also formed in an oval shape, as the open end 13b. In this manner, in the open end 13a as well as in the open end 13b, in the gas turbine 1, the stresses generated in the regions P at the open end 13a are also reduced. Accordingly, in the gas turbine 1, the uneven stress distribution generated in the open end 13a is reduced.

In FIG. 3, a virtual curved plane V03 is a virtual curved plane that is a curved plane about the rotational axis RL, and in which predetermine distances α from all the points on the curved plane to the rotational axis RL are all equal. In other words, the virtual curved plane V03 rotates about the rotational axis RL, and is a side surface of a cylinder in which the radius of the bottom surface and the upper surface is a predetermined distance α. The predetermined distance α is a distance equal to or more than a distance from the rotational axis RL to the open end 13a, and equal to or less than a distance from the rotational axis RL to the open end 13b.

Similar to the open end 13a and the open end 13b, in the cross-sectional shape of the radial passage 13 at the virtual curved plane V03, the length w in the circumferential direction of the disk 114 is longer than the length h in the direction parallel to the rotational axis RL. In this manner, in the gas turbine 1, similar to the open end 13a and the open end 13b, the stresses generated in regions that pass through the centroid of the cross-section and that are perpendicular to the force F applied to the edge of the cross-section, are reduced.

Accordingly, in the gas turbine 1, the uneven stress distribution generated in the cross-section is reduced. In other words, in the gas turbine 1, the uneven stress distribution generated in the radial passage 13 is reduced, as well as in the open end 13a and the open end 13b.

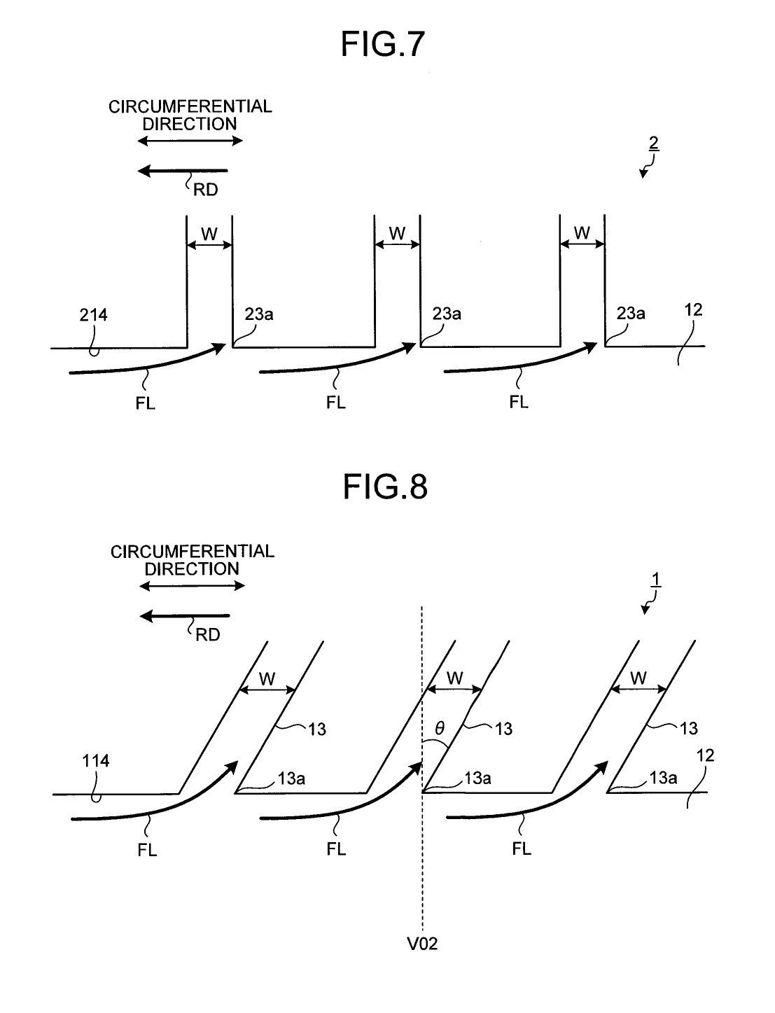

FIG. 7 is a projection view of the radial passages formed in the conventional disk near inner open ends, projected on a plane perpendicular to the rotational axis from the rotational axis direction. FIG. 8 is a projection view of the radial passages formed in the disk according to the present embodiment near inner open ends, projected on a plane perpendicular to the rotational axis from the rotational axis direction.

The cooling air is guided to the radial passage 13 from the first space 12 illustrated in FIG. 2, through the open end 13a. At this time, as illustrated in FIG. 3 by an arrow RD, the disk 114 rotates in a predetermined rotational direction. In this manner, when viewed from the radial passage 13, as illustrated in FIG. 8 by arrows FL, the cooling air seems to flow into the open ends 13a.

In the gas turbine 2, as illustrated in FIG. 4, the angle θ is 0 degree. Accordingly, as illustrated in arrows FL in FIG. 7, the cooling air collides with the wall surfaces of the open ends 23a. Accordingly, the cooling air does not flow into the radial passages 23 easily.

In the gas turbine 1, as illustrated in FIG. 8, the angle θ is formed between the radial passage 13 and the virtual reference plane V02. In other words, the radial passages 13 are tilted relative to the virtual reference plane V02. The radial passages 13 are tilted toward the region opposite from the rotational direction of the disk 114 illustrated in FIGS. 3 and 8 by the arrow RD, relative to the virtual reference plane V02.

In this manner, as illustrated in the arrows FL in FIG. 8, the cooling air flows into the radial passages 13, because the collision of the cooling air with the wall surfaces of the open ends 13a is eased. In other words, the cooling air flows into the radial passages 13 more easily than into the radial passages 23.

At the open ends 13a, as illustrated in FIGS. 6 and 8, the length w in the circumferential direction of the disk 114 is longer than the length w of the open ends 23a in the circumferential direction of the disk 214 illustrated in FIGS. 5 and 7, because the open ends 13a are formed in oval shapes. Accordingly, as illustrated in the arrows FL in FIG. 8, the cooling air flows into the open ends 13a more easily than into the open ends 23a.

In this manner, in the gas turbine 1, the flow velocity of the cooling air supplied to the radial passage 13 is increased. With this, in the gas turbine 1, the flow velocity of the cooling air supplied to the cooling passage 15 illustrated in FIG. 2 is also increased. Consequently, in the gas turbine 1, the heat exchange between the cooling air, the turbine rotor blades 113, and the disks 114 is enhanced. In other words, in the gas turbine 1, the disks 114 and the turbine rotor blades 113 are cooled more.

As illustrated in FIG. 3, the passage of the radial passage 13 through which the cooling air flows is longer than that of the radial passage 23 illustrated in FIG. 4, because the radial passage 13 is tilted relative to the virtual reference plane V02. Accordingly, in the gas turbine 1 that includes the radial passages 13, the contact area of the cooling air and the turbine rotor blades 113 is increased. In this manner, in the gas turbine 1, the heat exchange between the cooling air and the turbine rotor blades 113 is further enhanced. In other words, the turbine rotor blades 113 in the gas turbine 1 are cooled more.

The angle θ, for example, is set to 30 degrees. However, the present embodiment is not limited thereto. If the angle θ is set equal to or more than 10 degrees and equal to or less than 45 degrees, in the gas turbine 1, the uneven stress distribution generated in the radial passage 13 is reduced. Accordingly, the cooling performance of the gas turbine 1 by the cooling air is enhanced.

As described above, the radial passages 13 are formed from the radially outside of the disk 114 toward the radially inside of the disk 114, for example, by the drill. An embodiment of a method for forming the radial passage 13 will now be described.

Usually, as the radial passages 23 illustrated in FIG. 4, to form a passage in which the extended line intersects with the rotational axis RL, the leading end of a drill blade is directed toward the rotational axis RL. However, in the present embodiment, as illustrated in FIG. 3, a drill blade D is shifted from the virtual plane V01 to a position separated by a predetermined distance β, and while forming the radial passages 13, the drill blade D is moved parallel to the virtual plane V01.

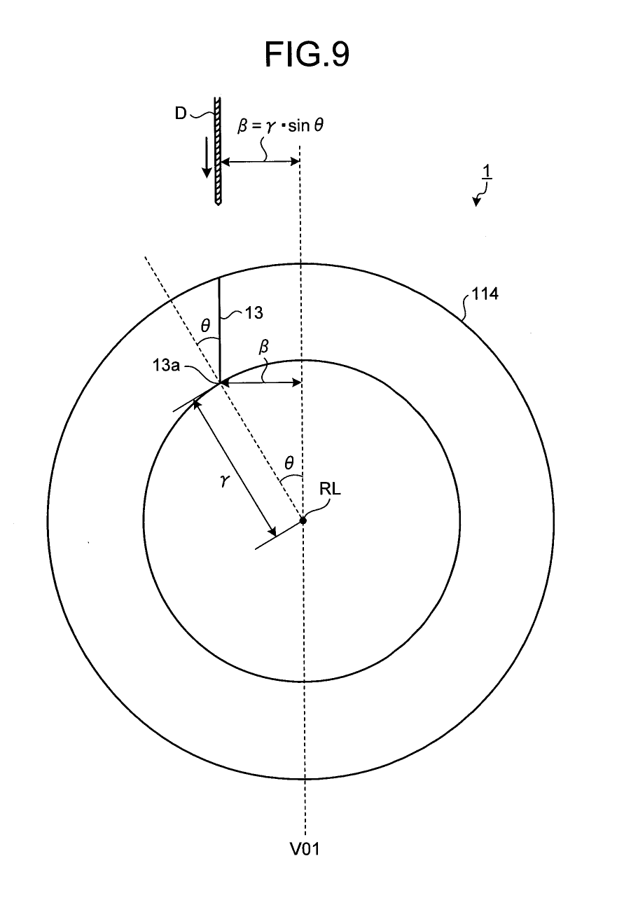

FIG. 9 is a schematic for explaining a shifting amount of a drill blade from a virtual plane, while forming the radial passage according to the present embodiment. The predetermined distance β, as illustrated in FIG. 9, is calculated by a distance r from the rotational axis RL to the open end 13a, and the angle θ. More specifically, the predetermined distance β is a product of the distance r and sin θ.

A worker who forms the radial passages 13, attaches the disk 114 formed in a disk shape on a drilling machine at first. At this time, the drill blade D is arranged parallel to the virtual plane V01, and shifted from the virtual plane V01 by the predetermined distance β. The worker forms the first radial passage 13 under these conditions.

The worker then rotates the disk 114 about the rotational axis RL by a predetermined angle. The predetermined angle is calculated by the number of radial passages 13 to be provided in the disk 114. For example, if a predetermined number γ of the radial passages 13 are formed in the disk 114, the disk 114 is rotated by an angle obtained by dividing 360 by the predetermined number γ. At this state, the worker forms the second radial passage 13. Thereafter, the worker repeats the procedure of rotating the disk by a predetermined angle and the procedure of forming the radial passage 13, until a desired number of radial passages 13 are formed in the disk 114.

In this manner, in the gas turbine 1, the radial passages 13 can be easily formed by using a conventional machine tool. Accordingly, in the gas turbine 1 that includes the radial passages 13, as described above, the uneven stress distribution generated in the radial passages 13 is reduced. In the gas turbine 1 that includes the radial passages 13, as described above, the disks 114 and the turbine rotor blades 113 are cooled more appropriately.

The radial passages 13, for example, are formed in straight lines. However, the present embodiment is not limited thereto. Each of the radial passages 13, for example, may be formed in a shape in which a plurality of straight lines is combined, in other words, in a bent shape. In this case, the portion with the angle θ is preferably formed near the open end 13a or the open end 13b of the radial passage 13.

If the portion with the angle θ is formed near the open end 13a of the radial passage 13, as described above, the cooling air flows into the open end 13a of the tilted radial passage 13 easily. Accordingly, in the gas turbine 1, the disks 114 and the turbine rotor blades 113 are cooled more.

The open end 13b is most separated from the rotational axis RL, in the radial passage 13 formed in the disk 114. Accordingly, the largest force F is applied to the portion near the open end 13b in the radial passage 13. Consequently, if the portion with the angle θ is formed near the open end 13b in the radial passage 13, in the gas turbine 1, the uneven stress distribution generated in the portion where the largest force F is applied in the radial passage 13 is reduced.

In the gas turbine 1, as illustrated in FIG. 4, the angle θ may be set to 0 degree. However, in this case, the cross-section of the radial passage 13 at the virtual curved plane V03 is formed in an oval shape, unlike the radial passage 23 illustrated in FIGS. 4 and 5. For example, in the gas turbine 1, the radial passages 13 are formed by electric spark machining.

In this manner, even if the radial passages 13 do not have the angle θ, as illustrated in FIG. 6, the cross-sections of the radial passages 13 at the virtual curved plane V03 are formed in oval shapes in which the length w in the circumferential direction of the disk 114 is longer than the length h in the direction parallel to the rotational axis RL. Accordingly, in the gas turbine 1, as described above, the uneven stress distribution generated in the radial passage 13 is reduced.

The “oval shape” in the present embodiment is not necessarily limited to an accurate oval shape. In other words, the shape of the cross-section of the radial passage 13 at the virtual curved plane V03 is not limited to a curve formed by a collection of points in which the sum of the distances from two specific points on the plane is constant. The shape of the cross-section of the radial passage 13 at the virtual curved plane V03 may be any shape provided it is an almost oval shape without a corner.

### INDUSTRIAL APPLICABILITY

In this manner, a gas turbine, a disk, and a method for forming a radial passage of a disk according to the present embodiment can be advantageously used for a gas turbine that includes radial passages through which cooling air flows in the radial direction of the disk. More specifically, a gas turbine, a disk, and a method for forming a radial passage of a disk according to the present embodiment are suitable for a gas turbine that reduces uneven stress distribution generated in the radial passage.

1. A gas turbine comprising:
a disk rotatable about a rotational axis, when a rotor blade for receiving combustion gas obtained by burning fuel is connected to a side periphery and energy of the combustion gas received by the rotor blade is transmitted; and
a radial passage that, in a cross-section at a virtual curved plane that is a curved plane about the rotational axis and in which distances from all points on the curved plane to the rotational axis are all equal, is a hole formed to include a portion having a shape in which a length in a circumferential direction of the disk is longer than a length in a direction parallel to the rotational axis, and is formed in the disk from a side of the rotational axis toward an outside of the disk.

2. The gas turbine according to claim 1, wherein the radial passage includes a portion other than that included in a virtual plane having the rotational axis.

3. The gas turbine according to claim 2, wherein a first open end of the radial passage is opened to a space formed at an inner side of the side periphery of the disk, and a second open end is opened to the side periphery of the disk, and when the radial passage is projected on a plane perpendicular to the rotational axis from a direction of the rotational axis, the radial passage has an angle equal to or more than 10 degrees and equal to or less than 45 degrees relative to a virtual reference plane including the first open end and the rotational axis.

4. The gas turbine according to claim 3, wherein the disk is rotatable toward a predetermined rotational direction, and the radial passage is tilted to a region opposite from the rotational direction, relative to the virtual reference plane at a portion of the first open end.

5. A disk, in a cross-section at a virtual curved plane that is a curved plane about a rotational axis and in which distances from all points on the curved plane to the rotational axis are all equal, the disk comprising a radial passage that is a hole formed to include a portion having a shape in which a length in a circumferential direction of the disk is longer than a length in a direction parallel to the rotational axis, and that is formed in the disk from a side of the rotational axis toward an outside of the disk.

6. A method for forming a radial passage of a disk, the method comprising:
a first step of attaching a disk formed in a disk shape on a drilling machine in which a drill blade is arranged in parallel with a virtual plane including a rotational axis of the disk, and being shifted from the virtual plane by a predetermined distance;
a second step of forming a first radial passage that is a hole in the disk, by moving the drill blade in parallel with the virtual plane;
a third step of rotating the disk about the rotational axis by a predetermined angle;
a fourth step of forming a second radial passage that is a hole in the disk, by moving the drill blade in parallel with the virtual plane; and
a fifth step of repeating the third step and the fourth step until a desired number of radial passages are formed in the disk.
